(19) United States
(12) Patent Application Publication
(10) Pub. No.: US 2021/0362519 A1
(43) Pub. Date: Nov. 25, 2021

(54) PAPER HANDLING SYSTEM FOR VARIABLY CONTROLLING FEEDING SPEED OF FEED ROLLER

(71) Applicant: Hewlett-Packard Development Company, L.P., Spring, TX (US)

(72) Inventors: Sungchang HUR, Seongnam-si (KR); Myung-Soo JUNG, Seongnam-si (KR)

(21) Appl. No.: 17/269,625

(22) PCT Filed: Jul. 24, 2019
(86) PCT No.: PCT/US2019/043162

§ 371 Date: Feb. 19, 2021

(30) Foreign Application Priority Data
Sep. 10, 2018 (KR) 10-2018-0107901

(51) Int. Cl. B41J 11/42; B65H 5/06; B65H 7/06; B65H 9/00; G03G 15/00

(52) U.S. Cl. CPC B41J 11/42; B65H 5/06; G03G 15/6529; B65H 9/002; B65H 7/06

(57) ABSTRACT

An image forming apparatus is provided. The image forming apparatus includes a print engine to form an image on a sheet, a feeding apparatus to pick up a sheet loaded onto a knock-up plate and feed the picked-up sheet to the print engine by using a pick-up roller, a feed roller, and a registration roller, and a processor to, based on a print data being received, control the print engine and the feeding apparatus and allow the received print data to be printed. The processor may variably control a feeding speed of the feed roller and allow the picked-up sheet is conveyed to the registration roller within a predetermined time.

### BACKGROUND

An image forming apparatus is an apparatus which performs generation, printing, reception, and transmission of image data, and representative examples thereof include a printer, a copy machine, a facsimile, a scanner, and a multifunction peripheral (MFP) in which functions of the above-described devices are combined.

In recent years, advances in printing technology have allowed for the development of image forming apparatuses that operate at faster speeds. In image forming apparatuses that perform at faster speeds, the feeding reliability of a printing medium such as paper is an important factor representing product performance.

As the image forming apparatus performs at a faster speed, a technique for controlling a distance between a printing medium, such as paper, has become more important.

### BRIEF DESCRIPTION OF THE DRAWINGS

Examples of the present disclosure will become more apparent from the following description taken in conjunction with the accompanying drawings, in which:

FIG. 1 is a block diagram illustrating a configuration of an image forming apparatus, according to an example;

FIG. 2 is a diagram illustrating an image forming apparatus, according to an example;

FIG. 3 is a cross-sectional view illustrating a feeding apparatus, according to an example;

FIG. 4 is an enlarged view of section “IV” illustrated in FIG. 3, according to an example;

FIG. 5 is a graph illustrating a conveying state of paper when the paper is picked up from an image forming apparatus and transferred using a speed component, according to an example;

FIG. 6 is a graph in which first and second sheets are enlarged in the graph of FIG. 5, according to an example;

FIG. 7 is a flowchart of a paper conveying method, according to an example;

FIG. 8 is a flowchart of a paper conveying method, according to an example; and

FIG. 9 is a flowchart of a paper conveying method, according to an example.

The same reference numerals are used to represent the same or similar elements, features, parts, components, and structures throughout the drawings.

### DETAILED DESCRIPTION

Various examples will be described below with reference to the accompanying drawings. The examples described below may be modified and implemented in various different forms. In order to more clearly describe the features of the examples, a detailed description of known matters to those skilled in the art will be omitted.

In the following description, a case in which any one feature is connected with another feature includes a case in which the features are directly connected with each other and a case in which the features are indirectly (e.g., electrically) connected with each other with other features interposed therebetween. Further, when a first certain feature is stated as “comprising” a second certain feature, unless otherwise stated, this means that the first certain feature may include another feature, rather than foreclosing the same.

The term “image forming job” as used herein may mean various jobs related to the image (e.g., printing, copying, scanning, or faxing), such as forming an image or creating/storing/transmitting an image file. In addition, the term “job” may mean not only an image forming operation but also a series of processes necessary for performing an image forming operation.

An image forming apparatus generally operates to print out print data generated at a terminal such as a computer onto a printing paper. An example of an image forming apparatus includes a copier, a printer, a scanner, a facsimile, and a multifunction peripheral (MFP) that provides combined functionality of at least two of the single apparatuses. The image forming apparatus may refer to any apparatus capable of performing an image forming operation, such as a copier, a printer, a scanner, a fax machine, an MFP, a display apparatus, or the like.

In addition, the term “hard copy” may refer to an operation of outputting an image on a printing medium such as paper, and the like, and “soft copy” may refer to an operation of outputting an image to a display apparatus, such as a TV, a monitor, and the like, or to a memory.

In addition, the term “content” may refer to any type of data that is subject to an image forming operation, such as a photo, an image, a document file, or the like.

In addition, the term “print data” may refer to data that is converted into a format printable in a printer. Meanwhile, if a printer supports direct printing, the file itself may be print data.

In addition, the term “user” may refer to a person who performs an operation related to an image forming operation using an image forming apparatus or a device connected to the image forming apparatus via wire or wirelessly. In addition, the term “manager” may refer to a person who has the authority to access all functions and the system of the image forming apparatus. The “manager” and the “user” may be the same person.

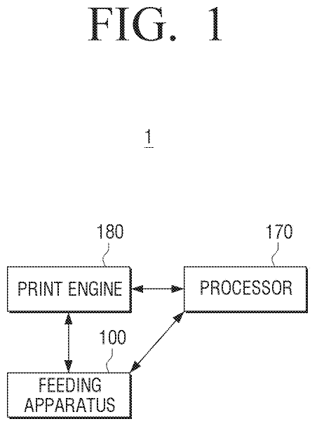

FIG. 1 is a block diagram illustrating a configuration of an image forming apparatus, according to an example.

Referring to FIG. 1, an image forming apparatus 1 may include a print engine 180, a feeding apparatus 100, and a processor 170.

The print engine 180 may perform an image forming job. The print engine 180 may perform an image forming job by forming an image on a paper P and performing an operation of transcribing the formed image on the paper P. An example configuration and operation of the print engine 180 will be described later.

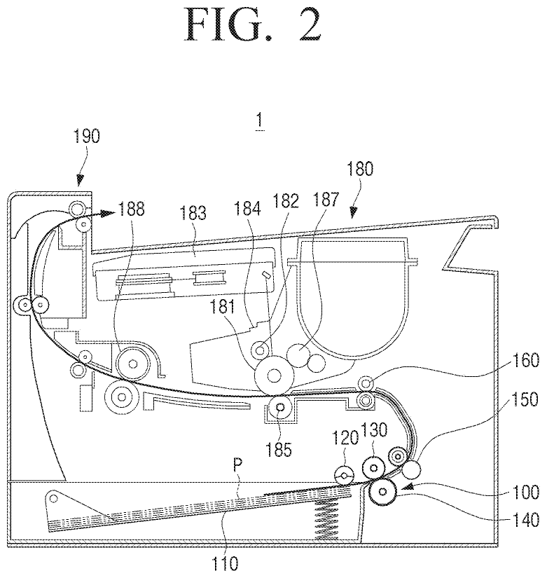

The feeding apparatus 100 may move a loaded paper P to a transfer path. For example, the feeding apparatus 100 may pick up a paper P loaded onto a knock-up plate and convey the picked-up paper P to a transfer path so that the paper P is provided to the print engine 180. To this end, the feeding apparatus 100 may include at least one driving source, a plurality of rollers, etc. An example composition and operation of a feeding apparatus 100 will be described below by referring to FIG. 2.

The processor 170 controls the respective configurations in the image forming apparatus 1. For example, when print data is received from a print control terminal apparatus, the processor 170 may control an operation of the print engine 180 to print the received print data, and control the feeding apparatus 100 to provide the paper P to the print engine 180.

The processor 170 may control the feeding apparatus 100 to increase a separation efficiency between papers P in order to prevent multiple papers P from being fed at the same time (e.g., multifeed).

A technique for controlling a distance between papers is important for acceleration of the image forming apparatus 1. The acceleration of the image forming apparatus 1 may be implemented to increase a process speed of a print job. However, if a process speed of a print job is increased by increasing a speed of a driving motor, there may be a problem of noise, vibration, image control, etc., and printing quality may be deteriorated.

Accordingly, to increase a motor speed by minimizing a distance between papers at a minimum and to increase a process speed of a print job at a minimum, the image forming apparatus according to an example may perform a minimum span control.

In more detail, the processor 170 may variably control a feeding speed (v(t)) of a feed roller so that the feed roller transfers the picked-up paper P to a registration roller within a predetermined time.

For example, the processor 170 may set the feeding speed (v(t)) of the feed roller so that the picked-up paper P is transferred to the registration roller within a predetermined time, and control the feed roller to be operated at the preset feeding speed (v(t)).

The processor 170 may set the feeding speed (v(t)) as a value which is obtained by dividing a distance from a feed sensor to a registration sensor which will be described below, by a time change (Δt) obtained by subtracting a time (Xt(n)), at which a leading edge of a paper P is detected in the feed sensor after a paper pickup command, from a predetermined time (t2).

The processor 170 may measure a paper interval (ΔSt) through a difference between a first time (St0) at which a rear edge of a preceding paper P reaches the feed sensor and a second time (St1) at which a leading edge of a following paper P reaches the feed sensor.

The processor 170 may compare the measured paper interval (ΔSt) with a predetermined paper interval (Stm) and set a feeding speed (v(t)).

If the measured paper interval (ΔSt) is less than or equal to the predetermined paper interval (Stm), the processor 170 may reflect a difference between the predetermined paper interval (Stm) and the measured paper interval (ΔSt) in the feeding speed (v(t)) and set the feeding speed (v(t)) to be lowered.

If the measured paper interval (ΔSt) is less than or equal to the predetermined paper interval (Stm), the processor 170 may set the feeding speed (v(t)) as a value which is obtained by dividing a distance from the feed sensor to the registration roller by a time (Δt−(Stm−ΔSt)) obtained by subtracting a difference between the measured paper interval and the predetermined paper interval (Stm−ΔSt) from the time change (Δt).

The processor 170 may measure a time (Xt(n)) at which a leading edge of a picked-up paper P is sensed in the feed sensor, and set a feeding speed (v(t)) based on the measured time (Xt(n)).

The processor 170 may accelerate or decelerate a driving motor (not illustrated) driving the feed roller so that the feed roller is operated at the preset feeding speed (v(t)).

The processor 170 may variably control a speed of the feed roller only when a preceding paper P is present. For example, the processor 170 may not control a feeding speed of the feed roller for a first paper P, and from a second paper P and thereafter, set the feeding speed (v(t)) and control the feed roller to be driven at the preset feeding speed (v(t)).

Accordingly, it is possible to minimize and stably maintain a paper interval between papers, and thereby a process speed of a print job can be increased at a minimum and printing quality of an image forming apparatus can be thus improved.

An example configuration and operation for a paper conveyance control by the processor 170 will be described later with reference to the accompanying drawings.

Meanwhile, although the above illustrates and explains a simple constitution of an image forming apparatus, various other units may be additionally included in actual implementation. For example, if the image forming apparatus 1 supports a scan function, a scan part may be further included. If a facsimile transmission/reception function is provided, a facsimile transceiver may be further included, and a feature such as a touch screen for displaying a state of the image forming apparatus may be further included.

FIG. 2 is a diagram illustrating an image forming apparatus, according to an example. An image forming apparatus 1 including a feeding apparatus according to an example will be described below.

Referring to FIG. 2, the image forming apparatus 1 may include a feeding apparatus 100, a knock-up plate 110, a pickup roller 120, a forwarding roller 130, a retard roller 140, a feed roller 150, a registration roller 160, a print engine 180, and a discharging part 190.

The feeding apparatus 100 may be configured to receive sheets of paper P, to pick up the papers P one at a time, and to provide each sheet of paper P to the print engine 180.

The print engine 180 may form a predetermined image on a paper P provided from the feeding apparatus 100. The print engine 180 may include a photosensitive drum 181, a charger 182, an exposure device 183, a developer 184, a transferring apparatus 185, and a fusing apparatus 188. In the example of FIG. 2, the print engine 180 and the feeding apparatus 100 are different elements, but the feeding apparatus 100 may be an element in the print engine 180.

An electrostatic latent image is formed on the photosensitive drum 181. For example, an image may be formed on the photosensitive drum 181 by an operation of the charger 182 and the exposure device 183, which will be described later. The photosensitive drum 181 may be referred to as an image forming medium, a photosensitive drum, a photosensitive belt, and the like, according to its form.

Hereinafter, for convenience of explanation, the feature of the print engine 180 corresponding to one color will be described as an example, but at the time of implementation, the print engine 180 may include a plurality of photosensitive drums 181 corresponding to a plurality of colors, a plurality of chargers 182, a plurality of exposure devices 183, a plurality of developing devices 184, and an intermediate transfer belt.

The charger 182 charges the surface of the photosensitive drum 181 to a uniform potential. The charger 182 may be implemented as a corona charger, a charging roller, a charging brush, and the like.

The exposure device 183 may change the surface potential of the photosensitive drum 181 based on information on an image to be printed to form an electrostatic latent image on the surface of the photosensitive drum 181. As an example, the exposure device 183 may form an electrostatic latent image by irradiating the photosensitive drum 181 with light modulated in accordance with the information on the image to be printed. An exposure device 183 of this type may be referred to as a light scanning device or the like, and a light emitting diode (LED) may be used as a light source.

The developer 184 accommodates a developing agent therein, and develops the electrostatic latent image into a visible image through supply of the developing agent (e.g., a toner) onto the electrostatic latent image. The developer 184 may include a developing roller 187 for supplying the developing agent to the electrostatic latent image. For example, the developer may be supplied from the developing roller 187 to the electrostatic latent image which is formed on the photosensitive drum 181 by the developing electric field formed between the developing roller 187 and the photosensitive drum 181.

The visible image which is formed on the photosensitive drum 181 is irradiated to a paper P by the transferring apparatus 185 or an intermediate transfer belt (not illustrated). The transferring apparatus 185 may transfer the visible image to a paper P, for example, by the electrostatic transfer method. The visible image is attached to the paper P by electrostatic attraction.

The fusing apparatus 188 fuses a visible image on the paper P by applying heat and/or pressure to a visible image on the paper P. The printing operation is completed by this series of processes.

In addition, the feeding apparatus 100 according to an example may be applicable to inkjet printers. The print engine 180 may include an ink ejection head (not illustrated) ejecting certain ink according to print data.

The discharge part 190 may discharge the paper P on which the certain image is formed, outside while passing through the print engine 180. The discharge part 190 may be configured with a pair of discharge rollers.

As described above, the disclosure may be applied not only to an image forming apparatus of an S path-type but also to an image forming apparatus of a C path-type. In the illustrated example, only one loading container is provided. However, an image forming apparatus may include a plurality of loading containers and the feeding apparatus 100 may provide papers P in the respective loading containers to the print engine 180.

A structure of a feeding apparatus according to an example will be described below.

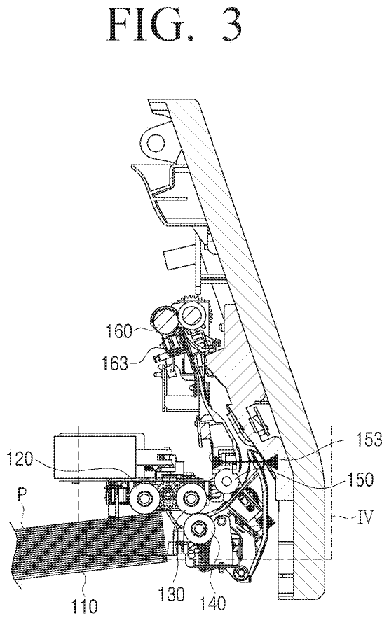

FIG. 3 is a cross-sectional view illustrating a feeding apparatus, according to an example.

Referring to FIG. 3, a feeding apparatus 100 may include a knock-up plate 110, a pickup roller 120, a forwarding roller 130, a retard roller 140, a feed roller 150, and a registration roller 160.

Along a paper transferring path, sequentially, the pickup roller 120, the forwarding roller 130, the retard roller 140, the feed roller 150, and the registration roller 160 may be disposed.

The knock-up plate 110 may push up a loaded paper P so that the pickup roller 120 and the paper P are in contact with each other. The pickup roller 120 may pick up the paper P to provide a paper P supported by the knock-up plate 110 to the print engine 180.

The feeding apparatus 100 may convey a plurality of mounted papers P to a direction of the print engine 180 one at a time using the knock-up plate 110 and the pickup roller 120. The feeding apparatus 100 may convey an uppermost paper P loaded onto the knock-up plate 110.

The picked-up paper P may pass between the forwarding roller 130 and the retard roller 140. The retard roller 140 may face the forwarding roller 130 and form a transfer nip N. The retard roller 140 may be in contact with a lower surface of a paper P which is transferred between the retard roller 140 and the forwarding roller 130 and provide a transferring force in an opposite direction to a paper conveyance direction.

The retard roller 140 may be elastically biased in a direction of the forwarding roller 130 so that the paper P transferred between the retard roller 140 and the forwarding roller 130 is in contact with the forwarding roller 130. A pressurization member (not illustrated) may be connected to the retard roller 140 so that the retard roller 140 is elastically biased in a direction of the forwarding roller 130.

The feed roller 150 may convey a transferring force to the paper P. The feed roller 150 may receive a driving force from a driving motor (not illustrated) and may be rotated in one direction. The feed roller 150 may come into contact with a surface of a paper P being supplied, and convey a transferring force to the paper P through a friction present on a surface of contact.

The feed roller 150 may be controlled by a processor (e.g., the processor 170 of FIG. 1) to be driven at a feeding speed (v(t)) which is set such that the picked-up paper P is transferred to the registration roller 160 within a predetermined time (t2). An example operation of the feed roller 150 will be described later.

The feeding apparatus 100 may include a feed sensor 153 to sense pick-up of the paper P and a registration sensor 163 indicating the set-off of the paper P after the paper P is aligned.

The feed sensor 153 may sense a paper P which is picked up by the pickup roller 120, thereby identifying whether the paper P is normally picked up and fed. The feed sensor 153 may be adjacently disposed to the feed roller 150, and may be disposed upstream of the feed roller 150.

The feed sensor 153 may sense a paper P that passes through the feed roller 150, and measure a time at which the paper P passes through the feed roller 150. The feed sensor 153 may be used as a detection means for measuring a distance between papers P, namely, a paper interval (ΔSt), and as a detection means for acceleration and deceleration of the feed roller 150. The processor 170 may set a feeding speed (v(t)) of the feed roller 150 based on a time point at which a paper P sensed by the feed sensor 153 passes through the feed roller 150 and time information, and variably control the feeding speed (v(t)).

The registration sensor 163 may sense a paper P that is skewed at a leading edge of the paper P. The registration sensor 163 may be adjacently disposed to the registration roller 160, and may be disposed downstream of the registration roller 160 on a paper transferring path.

The registration sensor 163 may sense a paper P that reaches the registration roller 160, and measure a time at which the paper P reaches the registration roller 160. The registration sensor 163 may be used as a detection means for an acceleration and deceleration control of a feeding speed (v(t)) of the feed roller 150.

The registration roller 160 may block traveling of the paper P which received a transferring force by means of the feed roller 150. When a leading edge of a paper P arrives at the registration roller 160, the registration roller 160 may suspend the paper P and align the paper P.

A paper P fed by the pickup roller 120 may be transferred to the registration roller 160 by the feed roller 150 along a transferring path. The transferring of the paper P may be blocked by the registration roller 160, and may be aligned by the registration roller 160. The paper P may be transferred toward the print engine 180. The paper P going through the registration roller 160 may pass through the print engine 180 and an image may be formed.

The feeding apparatus 100 may include a driving motor (not illustrated) driving the feed roller 150. The driving motor may be coupled with the feed roller 150 via a gear train and perform an acceleration and deceleration control of the feed roller 150.

The processor 170 may control the driving motor to drive the feed roller 150 at a feeding speed which is set such that the feed roller 150 transfers the paper P to the print engine 180. The processor 170 may perform an acceleration and deceleration control of the driving motor (not illustrated) so that the feed roller 150 is operated at a variable feeding speed.

The driving motor may drive the feed roller 150 at a preset feeding speed under the control of the processor 170.

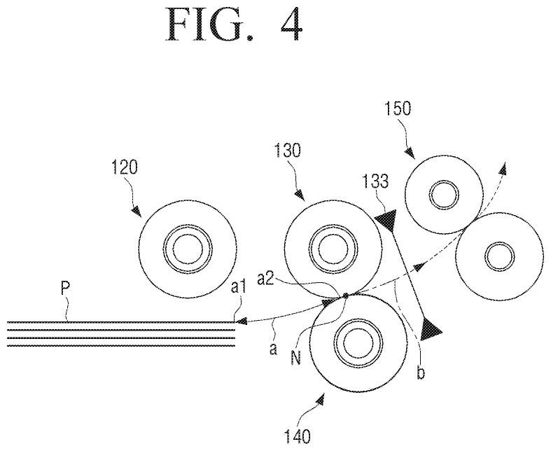

FIG. 4 is an enlarged view of section “IV” illustrated in FIG. 3, according to an example.

Referring to FIG. 4, the feeding apparatus 100 may further include a pre feed sensor 133.

The pre feed sensor 133 may be located upstream of a paper conveying direction with respect to the forwarding roller 130 and the retard roller 140. The pre feed sensor 133 may sense a picked-up paper P such that it is possible to identify whether a paper P is present when controlling the pick-up of the paper P.

When the paper P loaded onto the knock-up plate 110 is transferred along a paper transferring path, a location at which the paper P sets off may not be consistent. A paper set-off location (a) may be defined as a distance from a leading edge of a paper P loaded onto the knock-up plate 110 to a nip (N) between the forwarding roller 130 and the retard roller 140. A paper false set-off location (b) may be defined to be a case where a leading edge of a paper P is protruded to a paper conveying direction as compared with a nip (N) between the forwarding roller 130 and the retard roller 140.

A set-off location of a paper P in the image forming apparatus 1 is an important element to maintain and control a minimum paper interval and thus, when the paper P is sensed at the paper false set-off location (b), it is possible to additionally perform control to convey the paper P to the paper set-off location (a).

The pre feed sensor 133 may sense a set-off location of the paper P to be picked up.

If the pre feed sensor 133 is turned off, the paper P is at the paper set-off location (a) and thus, the processor 170 may perform a pick-up control of the paper P. When the pre feed sensor 133 is in an off state, the pickup roller 120 may perform a pick-up driving of the paper P.

When the pre feed sensor 133 is in an off state, the pickup roller 120 may be driven to pick up the paper P. The processor 170 may rotate the retard roller 140 in a direction opposite to the paper conveying direction to inversely convey the paper P. When the paper P reaches the paper set-off location (a) by backlashing and the pre feed sensor 133 is turned off, the processor 170 may drive the pickup roller 120 to perform a pick-up control.

However, even when the pre feed sensor 133 is in an off state, it is possible to immediately perform a pick-up control without performing a control of reverse feeding the paper P. In this case, in a minimum paper interval control which will be described below, it is possible to control a paper interval through a control of the feed roller 150.

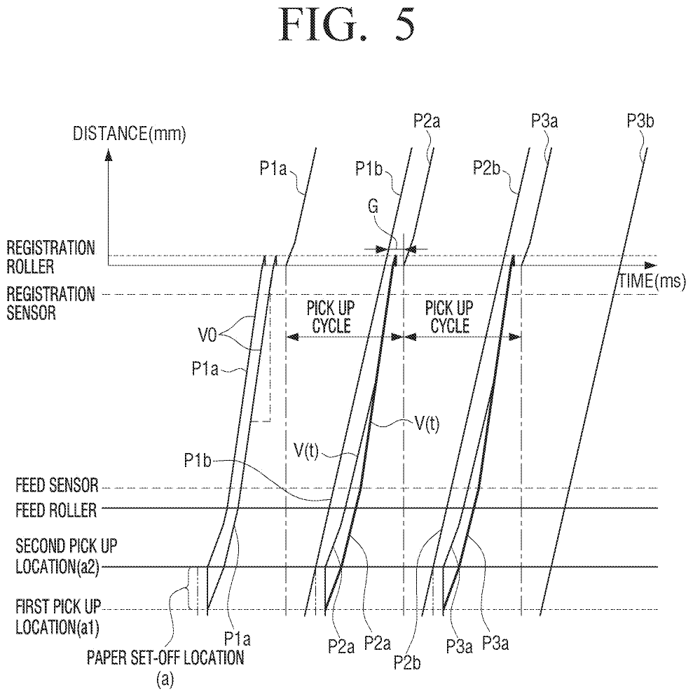

FIG. 5 is a graph illustrating a conveying state of paper when the paper is picked up from an image forming apparatus and transferred using a speed component, according to an example.

Referring to FIG. 5, a paper is picked up from the knock-up plate 110, and a state in which the paper is conveyed along a paper transferring path is shown in terms of time and distance. The x axis is a time axis (ms) and the y axis is a distance axis (mm). The y axis represents a length of a paper transferring path from a paper set-off location. An inclination of a straight line indicates movement of a leading edge of a paper and a rear edge of the paper represents a paper conveying speed (v(t)).

In FIG. 5, a graph of a leading edge (P1a) of a first sheet (P1) and a graph of a rear edge (P1b) of the first sheet (P1), a graph of a leading edge (P2a) of a second sheet (P2) and a graph of a rear edge (P2b) of the second sheet (P2), and a graph of a leading edge (P3a) of a third sheet and a graph of a rear edge (P3b) of the third sheet are illustrated.

It is possible to identify a conveying process of the first sheet (P1) through the graph of the leading edge (P1a) of the first sheet (P1) and the graph of the rear edge (P1b) of the first sheet (P1), and to identify that a variable control of a feeding speed (v(t)) of the feed roller 150 is carried out for a sheet that follows the second sheet (P2).

In addition, an interval between the graph of the leading edge (P1a) of the first sheet (P1) and the graph of the leading edge (P2a) of the second sheet (P2) and an interval between the graph of the leading edge (P2a) of the second sheet (P2) and the graph of the leading edge (P3a) of the third sheet represent a pick-up interval of the paper.

The processor 170 may not set a feeding speed (v(t)) for a minimum paper interval control for a sheet (P1) conveyed first, and drive the feed roller 150 at an initially-set feeding speed (v0).

When a paper is picked up, the first sheet (P1) is irrelevant to a paper interval because a preceding sheet is not present, even if a paper set-off location is different and a time at which the leading edge (P1a) of the first sheet (P1) reaches the registration roller 160 is different. Accordingly, when the first sheet (P1) is conveyed, the feed roller 150 may be driven at an initially-set feeding speed (v0) without changing the feeding speed (v0).

Since the time at which the sheet arrives at the registration roller 160 differs according to the paper set-off position of the sheet from the second paper, the difference of paper interval (G) may become large. Thus, it is necessary to perform a minimum paper interval control.

The processor 170 may set a feeding speed (v(t)) for a minimum paper interval control from a sheet conveyed secondly, and variably control the feeding speed (v(t)).

The processor 170 may variably control the feeding speed (v(t)) of the feed roller 150 so that the feed roller 150 conveys the picked-up sheet to the registration roller 160 within a predetermined time (t2) even if the paper set-off location is different.

By the feed roller 150 driving at the variable feeding speed (v(t)) according to the paper set-off location, the picked-up sheet having a different paper set-off location may reach the registration roller 160 within the predetermined time (t2). Accordingly, a paper interval (ΔSt), which is an interval between a rear edge of a preceding sheet and a leading edge of a following sheet, may be maintained consistently at a predetermined paper interval (Stm).

To accelerate the image forming apparatus 1 through a feeding speed control of the feed roller 150, a paper interval may be minimized and the minimized paper interval may be stably maintained. Accordingly, a motor load of the image forming apparatus 1 may be reduced by increasing a process speed of the image forming apparatus by a minimum amount, and thereby the life of the image forming apparatus 1 may be extended.

An example of a minimum paper interval of a processor will be described below.

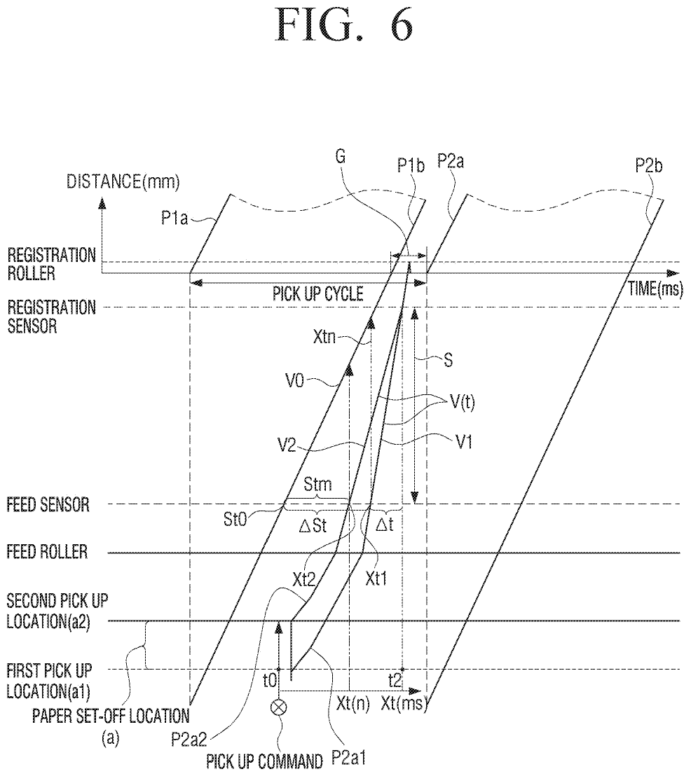

FIG. 6 is a graph in which first and second sheets are enlarged in the graph of FIG. 5, according to an example.

With regard to a preceding sheet (Pn) and a following sheet (Pn−1), for convenience of explanation, it will be described that the preceding sheet (Pn) is a first sheet (P1) and that the following sheet (Pn−1) is a second sheet (P2).

Referring to FIG. 6, as described above, when a sheet is picked up, a location of a leading edge of the sheet from which the sheet sets off may not be stably maintained and may be distributed over a wide range. According to an example, as the paper set-off location (a) is formed over a wide range, the image forming apparatus 1 may maintain a predetermined paper interval (Stm) by variably controlling a feeding speed (v(t)) with respect to the respective sheets having different set-off locations.

The processor 170 may variably control the feeding speed (v(t)) of the feed roller 150 to send the picked-up sheet to the registration sensor 163 within a predetermined time (t2). To this end, the processor 170 may control a driving motor (not illustrated) of the feed roller 150 so that the feed roller 150 may be driven at the variable feeding speed (v(t)).

The feeding speed (v(t)) may be calculated by Equation (1) as shown below.

v(t)=S/(Δt)

Δt=t2−Xt(n) Equation (1)

In Equation (1), S refers to a distance (S) from the feed sensor 153 to the registration sensor 163. The distance (S) from the feed sensor 153 to the registration sensor 163 is a design distance. A value of Δt is obtained by subtracting a time (Xt(n)) at which the sheet picked up based on a time (t0) when a pickup command is input is sensed in the feed sensor 153, by a time (t2) from the pickup command (t0) is input to a time (t2) at which the sheet reaches the registration sensor 163.

Here, the time t2 is a design time and the time Xt(n) is a measurement time. The time Xt(n) is a value measured by the feed sensor 153, which is a time at which, after the pick-up command is input (t0), the feed sensor 153 recognizes the sheet and is in an on state.

In this case, the sheet may reach the registration roller 160 within a predetermined time (t2) and thus maintain a predetermined paper interval (Stm) with respect to a preceding sheet (Pn).

Referring to the graphs (P2a1 and P2a2) of leading edges of the following sheets illustrated in FIG. 6, a paper set-off location (a) of a sheet to be picked up may be formed between a first location (a1) and a second location (a2).

The first location (a1) may refer to a location of a leading edge of a sheet loaded onto the knock-up plate 110, and the second location (a2) may refer to a location of a nip (N) between the forwarding roller 130 and the retard roller 140.

Referring first to a graph of a leading edge of the following sheet (P2a1) picked up at the first location (a1), the sheet picked up at the first location (a1) may be conveyed to the feed roller 150 at a consistent pickup speed (Vp).

The feed sensor 153 may sense the sheet conveyed by the feed roller 150, and may be in an on state. The feed sensor 153 may measure a time (Xt1) at which the sheet reaches the feed sensor 153.

The feeding speed (V1) of the sheet (P2a1) setting off at the first location (a1) may be a value which is obtained by dividing a distance (S) from the feed sensor 153 to the registration sensor 163 by a value obtained by subtracting a time (Xt1) at which the sheet (P2a1) picked up at the first location (a1) after a pickup command is sensed in the feed sensor 153 from a time (t2) at which the sheet arrives at the registration sensor 163 from when the pickup command is input.

Referring to the graph of the leading edge of the following sheet (P2a2) picked up at the second location (a2), the sheet (P2a2) picked up at the second location (a2) may also be conveyed to the feed roller 150 at the same pickup speed (Vp) as the sheet (P2a1) picked up at the first location (a1).

The feed sensor 153 may sense the sheet (P2a2) conveyed by the feed roller 150, and may be in an on state. The feed sensor 153 may measure a time (Xt2) at which the sheet (P2a2) reaches the feed sensor 153.

The feeding speed (V2) of the sheet (P2a2) setting off at the second location (a2) may be a value which is obtained by dividing a distance (S) from the feed sensor 153 to the registration sensor 163 by a value obtained by subtracting a time (Xt2) at which the sheet (P2a2) picked up at the second location (a2) after a pickup command is sensed in the feed sensor 153 from a time (t2) at which the sheet (P) arrives at the registration sensor 163 from when the pickup command is input.

The feeding speed (v1) of the feed roller 150 when the sheet (P2a1) picked up at the first location (a1) is conveyed may be set larger than the feeding speed (v2) of the feed roller 150 when the sheet (P2a2) picked up at the second location (a2) is conveyed.

The sheet (P2a1) picked up at the first location (a1) may be conveyed to the registration roller 160 at a faster feeding speed than the sheet (P2a2) picked up at the second location (a2). Accordingly, the sheet (P2a1) picked up at the first location a1 farther from the registration roller 160 than the second location a2 may arrive at the registration roller 160 within the same time (t2) as the sheet (P2a2) picked up at the second location (a2). Accordingly, even if a paper set-off location is different, the sheets (P2a1 and P2a2) may be conveyed to the registration roller 160 within the same predetermined time.

After being transferred to the registration roller 160, the sheet (P2a1) picked up at the first location (a1) and the sheet (P2a2) picked up at the second location (a2) may be conveyed toward the print engine 180 at the same speed.

The processor 170 may measure a paper interval (ΔSt) which is a distance between a preceding sheet (P1) and a following sheet (P2) in the feed sensor 153.

The paper interval (ΔSt) may be measured using the feed sensor 153. The paper interval (ΔSt) may be calculated using Equation (2) as shown below.

ΔSt=St1−St0 Equation (2)

In Equation (2), the variable St0 refers to a time point (St0) at which a rear edge of the preceding sheet (P1) passes through the feed roller 150 and the feed sensor 153 is turned off, and the variable St1 refers to a time point (St1) at which a leading edge of the following sheet (P2) enters the feed roller 150 and the feed sensor 153 is turned on.

The processor 170 may compare the measured paper interval (ΔSt) with a predetermined paper interval (Stm) and set a feeding speed (v(t)).

In a case that the measured paper interval (ΔSt) is larger than the predetermined paper interval (Stm), the feed roller 150 may be driven at a feeding speed (v(t)=S/(Δt). In this case, the sheet may reach the registration roller 160 within a predetermined time (t2) and thus maintain a predetermined paper interval (Stm) with respect to a preceding sheet (P1).

In a case that the measured paper interval (ΔSt) is less than or equal to the predetermined paper interval (Stm), a feeding speed may be set as shown below. If the measured paper interval (ΔSt) is less than the predetermined paper interval (Stm), a paper overlapping occurs and thus, the chances of jamming increase. Thus, to secure a minimum paper interval between sheets, it is possible to control the feeding speed (v(t)) to be decelerated.

In a case that the measured paper interval (ΔSt) is less than or equal to the predetermined paper interval (Stm), the feed roller 150 may be driven at a decelerated feeding speed (v(t)) so as to maintain the predetermined paper interval (Stm) between sheets.

In this regard, the decelerated feeding speed (v(t)) may be calculated by Equation (3) as shown below.

v(t)=S/(Δt+(Stm−ΔSt)) Equation (3)

In a case that the measured paper interval (ΔSt) is larger than the predetermined paper interval (Stm), the feed roller 150 may be driven at a feeding speed (v(t)=S/(Δt)). When the feeding speed (v(t)) is calculated, a time which is reduced according to a difference between the predetermined paper interval (Stm) and the measured paper interval (ΔSt) may be reflected in the feeding speed (v(t)) so as to set the feeding speed (v(t)) to be decelerated.

Accordingly, a predetermined paper interval (Stm) which is a minimum paper interval may be secured, a conveying speed of the sheet may be decelerated so as to reduce the possibility of jamming, and a predetermined paper interval (G) with respect to the preceding sheet (P1) may be maintained.

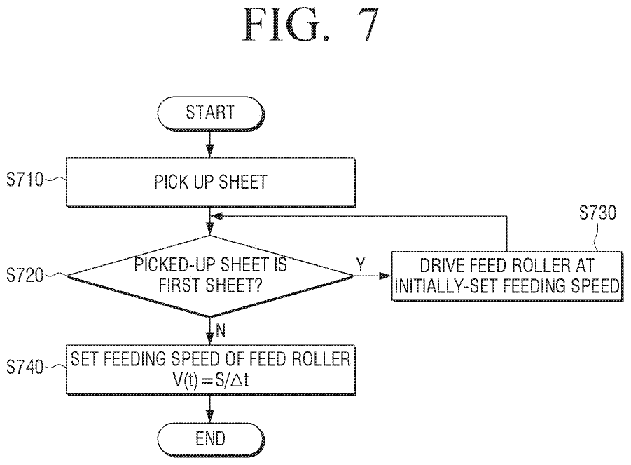

FIG. 7 is a flowchart of a paper conveying method, according to an example.

Referring to FIG. 7, when print data is received, the pickup roller 120 may pick up a sheet so as to print the received print data, at operation S710.

It is identified whether the picked-up sheet is a first sheet (P1) at operation S720. If the picked-up sheet is the first sheet (P1), the feed roller 150 may be driven at an initially-set feeding speed (v0) at operation S730. In a case of the first sheet (P1), no preceding sheet is present and thus, there would not be any problem related to a minimum paper interval or jamming. Thus, it is not necessary to variably control the feeding speed.

If the picked-up sheet is not the first sheet (P1), that is, if the picked-up sheet is a second sheet or greater, the feeding speed (v(t)) of the feed roller 150 may be variably controlled at operation S740. From the second sheet and thereafter, the feeding speed (v(t)) may be set as a value obtained by dividing a distance (S) from the feed sensor 153 to the registration sensor 163 by Δt.

The value of Δt is obtained by subtracting a time (Xt(n)) at which the sheet picked up based on a time (t0) when a pickup command is input is sensed in the feed sensor 153, by a time (t2) from the pickup command (t0) is input to a time (t2) at which the sheet reaches the registration sensor 163.

The feeding speed (v(t)) of the feed roller 150 may be varied according to a time (Xt(n)) at which the sheet arrives at the feed sensor 153. Accordingly, even when the paper set-off location is different and a time (Xt(n)) of arrival at the feed sensor 153 is different, the picked-up sheet may arrive at the registration roller 160 within a predetermined time (t2).

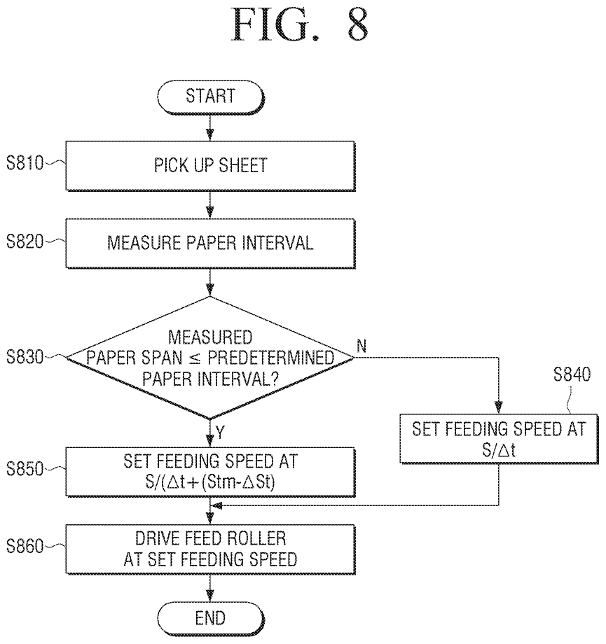

FIG. 8 is a flowchart of a paper conveying method, according to an example.

Referring to FIG. 8, when print data is received, the pickup roller 120 may pick up a sheet so as to print the received print data at operation S810.

A paper interval between a preceding sheet (P1) and a following sheet (P2) may be measured using the feed sensor 153 at operation S820. The measured paper interval is a distance between the preceding sheet (P1) and the following sheet (P2) measured in the feed sensor 153.

In more detail, the paper interval (ΔSt) may be calculated as a value obtained by subtracting a time point (St0) at which a rear edge of the preceding sheet (P1) passes through the feed roller 150 and the feed sensor 153 is turned off from a time point (St1) at which a leading edge of a following sheet (P2) enters the feed roller 150 and the feed sensor 153 is turned on.

A feeding speed (v(t)) may be set based on a comparison of a measured paper interval (ΔSt) with a predetermined paper interval (Stm) at operation S830.

In a case that the measured paper interval (ΔSt) is larger than the predetermined paper interval (Stm), the feed roller 150 may be driven at a feeding speed (V(t)=S/(Δt)) at operation S840. In this case, the sheet may reach the registration roller 160 within a predetermined time (t2) and thus maintain a predetermined paper interval (Stm) with respect to a preceding sheet (P1).

In a case that the measured paper interval (ΔSt) is less than or equal to the predetermined paper interval (Stm), the feed roller 150 may be driven at a feeding speed (v(t)=S/((Δt)+(Stm−ΔSt)) at operation S850. When the feeding speed (v(t)) is calculated, a time which is reduced according to a difference between the predetermined paper interval (Stm) and the measured paper interval (ΔSt) may be reflected in the feeding speed (v(t)) so as to set the feeding speed (v(t)) to be decelerated.

In this regard, a predetermined paper interval (Stm) which is a minimum paper interval may be secured, a conveying speed of the sheet may be decelerated so as to reduce the possibility of jamming, and a predetermined paper interval (Stm) with respect to the preceding sheet (P1) may be maintained.

The feed roller 150 may be driven at the feeding speed set as described above, at operation S860.

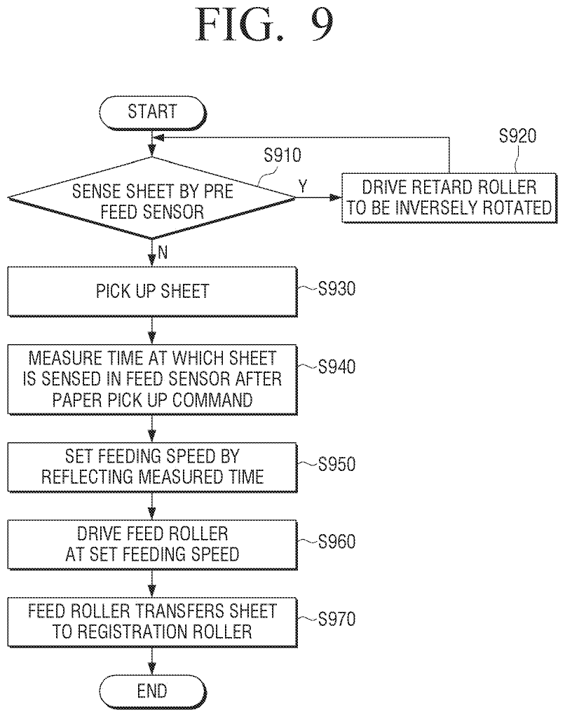

FIG. 9 is a flowchart of a paper conveying method, according to an example.

Referring to FIG. 9, when print data is received, whether a sheet is sensed is identified first by the pre feed sensor 133 before picking up a sheet so as to print the received print data at operation S910. The operation described above is to identify whether a set-off location is a paper set-off location.

When the sheet is sensed by the pre feed sensor 133, the retard roller 140 may be driven to rotate inversely at operation S920. A sheet sensed in the pre feed sensor 133 by the inverse rotation of the retard roller 140 may be conveyed to the opposite direction to the paper conveying direction and conveyed to the paper set-off location.

If the sheet is not sensed by the pre feed sensor 133, a sheet may be picked up at operation S930.

The sheet is conveyed to the feed roller 150 after the paper pickup command, and a leading edge of the sheet may be sensed by the feed sensor 153. As the feed sensor 153 is changed to an on state, a time (Xt(n)) at which the sheet arrives at the feed sensor 153 after the pickup command may be measured at operation S940.

The feeding speed (v(t)) of the feed roller 150 may be set by reflecting the measured time (Xt(n)) therein at operation S950. In more detail, the feeding speed (v(t)) may be set as a value which is obtained by dividing the distance from the feed sensor 153 to the registration sensor 163 by a value obtained by subtracting a measured time from when a pickup command is input (t0) to when the sheet arrives at the feed sensor 153 from a time (t2) from when the pickup command is input (t0) to when the sheet arrives at the registration sensor 163.

The feed roller 150 may be driven at the set feeding speed at operation S960. A driving motor of the feed roller 150 may be driven to accelerate or decelerate in order to vary the feeding speed (v(t)) of the feed roller 150.

The feed roller 150 may provide the sheet to the registration roller 160 at the set feeding speed (v(t)), at operation S970.

Accordingly, it is possible to minimize and stably maintain a paper interval between papers, and thereby a process speed of a print job can be increased at a minimum and printing quality of an image forming apparatus can be thus improved.

The paper conveying methods as shown in FIGS. 7-15 may be executed on the image forming apparatus having the configuration as shown in FIG. 1 or 2, and may be executed on an image forming apparatus having another configuration.

The above-described examples of paper conveying methods may be implemented in a program and provided to an image forming apparatus. In particular, a program including a paper conveying method according to examples may be stored in a non-transitory computer readable medium and provided therein.

The non-transitory computer readable medium refers to a medium that stores data semi-permanently rather than storing data for a very short time, such as a register, a cache, a memory or etc., and is readable by an apparatus. In more detail, the above-described various applications or programs may be stored in the non-transitory computer readable medium, for example, a compact disc (CD), a digital versatile disc (DVD), a hard disc, a Blu-ray disc, a universal serial bus (USB), a memory card, a read only memory (ROM), and the like, and may be provided.

The foregoing examples and advantages are merely exemplary and are not to be construed as limiting the present disclosure. The present teaching can be readily applied to other types of apparatuses. Also, the description of the examples of the present disclosure is intended to be illustrative, and not to limit the scope of the claims, and many alternatives, modifications, and variations will be apparent to those skilled in the art.

What is claimed is:

1. An image forming apparatus, comprising:
a print engine to form an image on a sheet;
a feeding apparatus to pick up a sheet loaded onto a knock-up plate and feed the picked-up sheet to the print engine by using a pick-up roller, a feed roller, and a registration roller; and
a processor to:
based on print data being received, control the print engine and the feeding apparatus to allow the received print data to be printed, and
variably control a feeding speed of the feed roller and allow the picked-up sheet to be conveyed to the registration roller within a predetermined time.

2. The image forming apparatus as claimed in claim 1, further comprising:
a feed sensor, disposed adjacently to the feed roller, to sense the sheet.

3. The image forming apparatus as claimed in claim 2, wherein the processor sets the feeding speed as a value which is obtained by dividing a distance from the feed sensor to the registration roller by a change of time obtained by subtracting a time at which a leading edge of the sheet is sensed after a pick-up command of the sheet from the predetermined time.

4. The image forming apparatus as claimed in claim 3, wherein the processor measures a paper interval of the paper through a difference between a time at which a rear edge of a preceding sheet arrives at the feed sensor measured by the feed sensor and a time at which a leading edge of a following sheet arrives at the feed sensor measured by the feed sensor.

5. The image forming apparatus as claimed in claim 4, wherein the processor sets the feeding speed by comparing the measured paper interval with a predetermined paper interval.

6. The image forming apparatus as claimed in claim 5, wherein the processor, based on the measured paper interval being less than the predetermined paper interval, sets the feeding speed to be decelerated by reflecting a difference between the predetermined paper interval and the measured paper interval in the feeding speed.

7. The image forming apparatus as claimed in claim 6, wherein the processor, based on the measured paper interval being less than the predetermined paper interval, sets the feeding speed as a value which is obtained by dividing a distance from the feed sensor to the registration roller by a time obtained by subtracting the change of time from a difference between the measured time and the predetermined time.

8. The image forming apparatus as claimed in claim 2, wherein the processor:
measures a time at which a leading edge of the picked-up sheet is sensed in the feed sensor; and
sets the feeding speed based on the measured time.

9. The image forming apparatus as claimed in claim 1, further comprising:
a driving motor to drive the feed roller,
wherein the processor controls the drive motor to be accelerated and decelerated, and allows the feed roller to be driven at the set feeding speed.

10. The image forming apparatus as claimed in claim 1, wherein the processor:
based on a preceding sheet being present, sets the feeding speed; and
controls the feed roller to be driven at the set feeding speed.

11. The image forming apparatus as claimed in claim 1, wherein the processor variably controls a feeding speed of the feed roller from a second sheet and thereafter.

12. A paper conveying method in an image forming apparatus, the paper conveying method comprising:
picking up a sheet using a pick-up roller;
setting a feeding speed of a feed roller to convey the picked-up sheet to a registration roller within a predetermined time; and
providing the picked-up sheet to a print engine by means of the feed roller being driven at the set feeding speed and the registration roller.

13. The paper conveying method as claimed in claim 12,
wherein the setting of the feeding speed comprises:
measuring a paper interval, which is an interval of time between a rear edge of a preceding sheet and a leading edge of a following sheet; and
comparing the measured paper interval and a predetermined paper interval, and
wherein the comparing comprises, based on the measured paper interval being larger than the predetermined paper interval, setting the feeding speed as a value which is obtained by dividing a distance from the feed roller to the registration roller by a change of time obtained by subtracting a time at which the leading edge of the sheet arrives at the feed roller after a paper pick-up command from the predetermined time.

14. The paper conveying method as claimed in claim 13, wherein the comparing comprises, based on the measured paper interval being less than the predetermined paper interval, setting the feeding speed as a value which is obtained by dividing a distance from the feed roller to the registration roller by a time obtained by subtracting a difference between the measured paper interval and the predetermined paper interval from the change of time.

15. The paper conveying method as claimed in claim 12, further comprising:
prior to the picking up of the sheet, sensing a set-off location of the sheet when a paper pick-up command is input,
wherein the sensing of the set-off location of the sheet comprises, based on the sheet being protruded from a forwarding roller, rotating a retard roller in an opposite direction to a paper conveying direction and conveying the sheet to such an extent that the sheet is not protruded from the forwarding roller.
